(19) United States
(12) Patent Application Publication
(10) Pub. No.: US 2019/0174965 A1
(43) Pub. Date: Jun. 13, 2019

(54) Friction Reducing Pad System

(71) Applicants: Jason Greer, Renton, WA (US); Joyce Greer, Renton, WA (US)

(72) Inventors: Jason Greer, Renton, WA (US); Joyce Greer, Renton, WA (US)

(21) Appl. No.: 15/839,924

(22) Filed: Dec. 13, 2017

(51) Int. Cl. A47J 47/00

(52) U.S. Cl. CPC A47J 47/00; A47J 43/07

(57) ABSTRACT

A friction reducing pad system for sliding an appliance along a support surface includes a pad that is selectively positioned on a support surface. An appliance is selectively positioned on the pad. The pad facilitates the appliance to be slid along the support surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to pad devices and more particularly pertains to a new pad device for sliding an appliance along a support surface.

### BRIEF SUMMARY OF THE INVENTION

An embodiment of the disclosure meets the needs presented above by generally comprising a pad that is selectively positioned on a support surface. An appliance is selectively positioned on the pad. The pad facilitates the appliance to be slid along the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view pad of a friction reducing pad system according to an embodiment of the disclosure.

FIG. 2 is a top view of a pad of an embodiment of the disclosure.

FIG. 3 is a perspective in-use view of an embodiment of the disclosure.

FIG. 4 is a top view of an alternative embodiment of the disclosure.

FIG. 5 is a perspective view of an alternative embodiment of the disclosure.

### DETAILED DESCRIPTION OF THE INVENTION

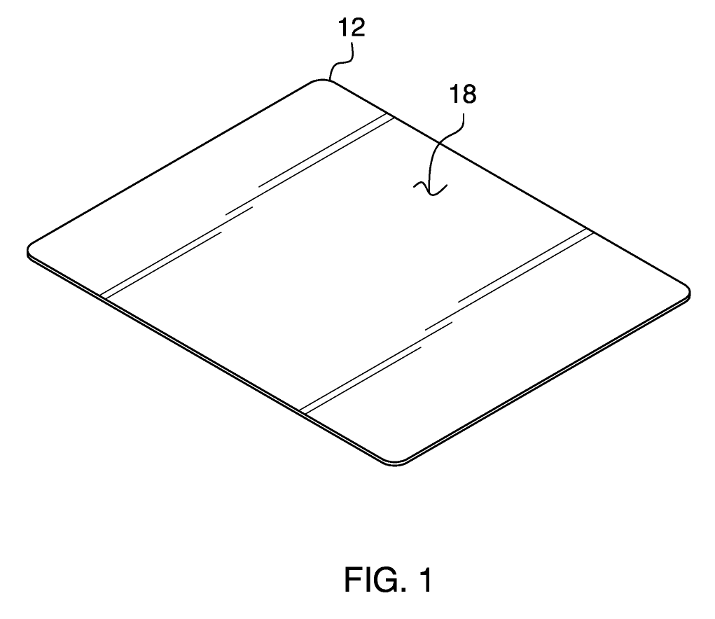

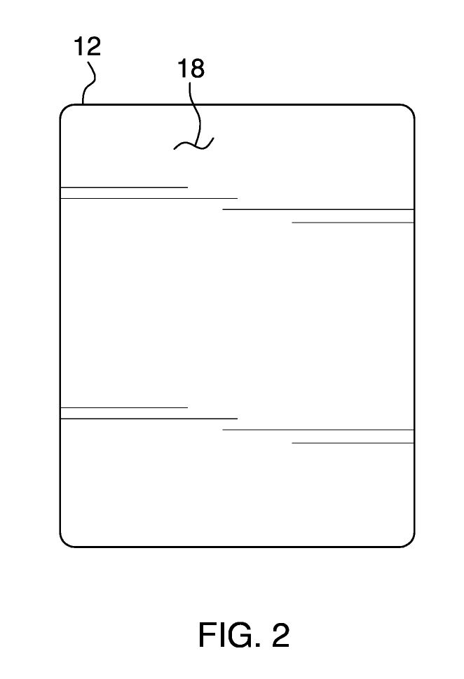

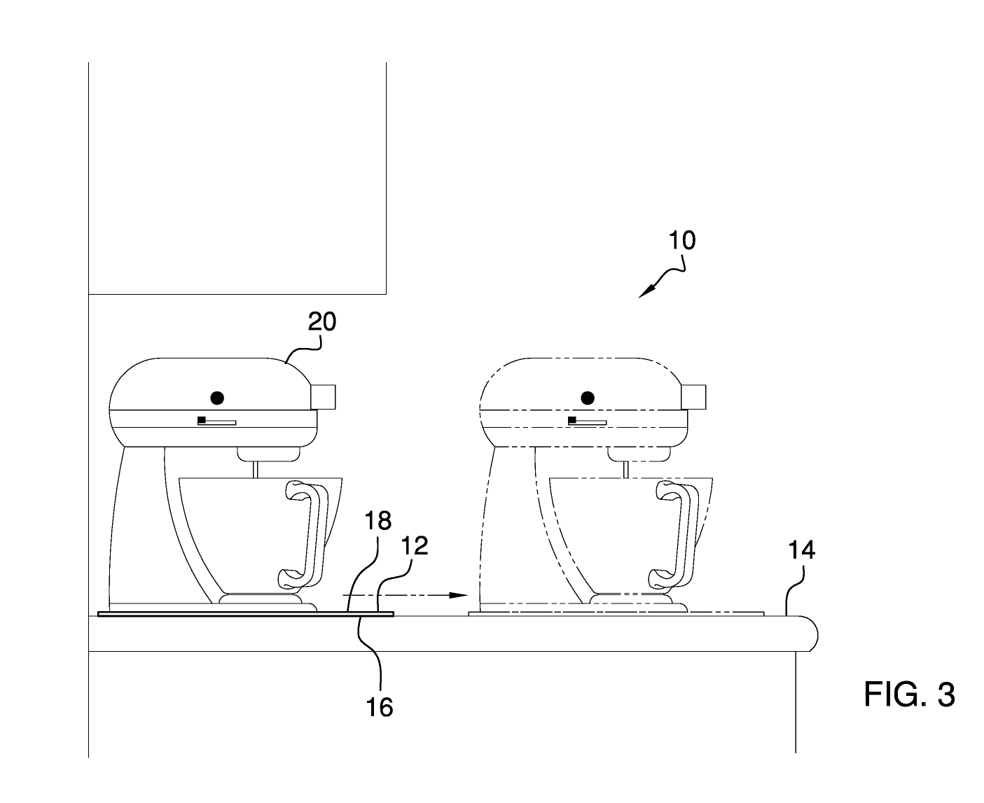

With reference now to the drawings, and in particular to FIGS. 1 through 5 thereof, a new pad device embodying the principles and concepts of an embodiment of the disclosure and generally designated by the reference numeral 10 will be described.

As best illustrated in FIGS. 1 through 5, the friction reducing pad system 10 generally comprises a pad 12 that is selectively positioned on a support surface 14 such as a counter top in a kitchen or the like. The pad 12 is comprised of a friction inhibiting material such as plastic, Teflon and other flexible, friction inhibiting material. Thus, the pad 12 is inhibited from frictionally engaging the support surface 14 thereby facilitating the pad 12 to be easily slid along the support surface 14. The pad 12 has a first surface 16 and a second surface 18 and the first surface 16 abuts the support surface 14. The pad 12 may have a length ranging between approximately 25.0 cm and 50.0 cm, a width ranging between approximately 20.0 cm and 40.0 cm and a thickness of approximately 2.0 mm.

An appliance 20 is provided and the appliance 20 is selectively positioned on the pad 12. Thus, the pad 12 facilitates the appliance 20 to be easily slid along the support surface 14. The appliance 20 is positioned on the second surface 18 of the pad 12. Additionally, the appliance 20 may be an electric kitchen appliance 20, a pot full of food and any other heavy object commonly found in a kitchen. The pad 12 facilitates the appliance 20 to be easily slid along the support surface 14 regardless of how heavy the appliance 20 is. In this way a single individual can easily reposition the appliance 20 on the support surface 14.

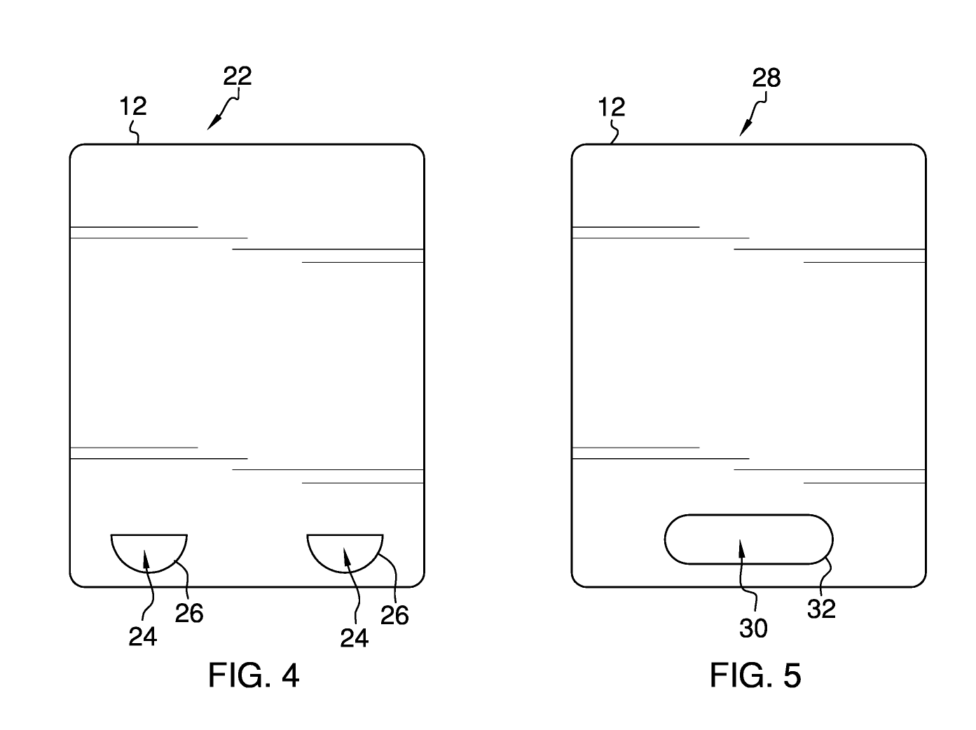

In an alternative embodiment 22 as shown in FIG. 4, a plurality of apertures 24 may extend through the first 16 and second 18 surfaces of the pad 12. The apertures 24 may be spaced apart from each other to define a pair of grips 26 on the pad 12. Thus, each of the grips 26 may be gripped to facilitate urging the pad 12 along the support surface 14 when the appliance 20 is sitting on the pad 12. In an alternative embodiment 28 as shown in FIG. 5, an opening 30 may extend through the first 16 and second 18 surfaces of the pad 12. The opening 30 may be longitudinally elongated to define a grip 32 on the pad 12. Thus, the grip 32 may be gripped to facilitate urging the pad 12 along the support surface 14 when the appliance 20 is sitting on the pad 12.

In use, the pad 12 is positioned on the support surface 14 and the appliance 20 is positioned on the pad 12. The pad 12 is selectively gripped and urged along the support surface 14 to selectively reposition the appliance 20 on the support surface 14. In this way a single individual may reposition the appliance 20 without having to lift the appliance 20. Additionally, the friction inhibiting quality of the pad 12 reduces the amount of effort required to move the appliance 20.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A friction reducing pad system being configured to have a kitchen appliance positioned thereon thereby facilitating the kitchen appliance to be slid along a support surface, said system comprising:
a pad being configured to be positioned on a support surface; and
an appliance being selectively positioned on said pad, said pad facilitating said appliance to be slid along the support surface.

2. The system according to claim 1, wherein said pad is comprised of a friction inhibiting material wherein said pad is configured to inhibit frictionally engaging the support surface thereby facilitating said pad to be slid along the support surface.

3. The system according to claim 2, wherein said pad has a first surface and a second surface, said first surface being configured to abut the support surface.

4. The system according to claim 2, wherein:
said pad has a first surface and a second surface; and
said appliance is positioned on a second surface of said pad.

5. A friction reducing pad system being configured to have a kitchen appliance positioned thereon thereby facilitating the kitchen appliance to be slid along a support surface, said system comprising:
a pad being configured to be positioned on a support surface, said pad being comprised of a friction inhibiting material wherein said pad is configured to inhibit frictionally engaging the support surface thereby facilitating said pad to be slid along the support surface, said pad having a first surface and a second surface, said first surface being configured to abut the support surface; and
an appliance being selectively positioned on said pad, said pad facilitating said appliance to be slid along the support surface, said appliance being positioned on said second surface of said pad.
